(19) United States
(12) Patent Application Publication
(10) Pub. No.: US 2020/0215878 A1
(43) Pub. Date: Jul. 9, 2020

(54) ELECTROSTATIC AIR CLEANER FOR EXPRESS BUS AND AIR CLEANING METHOD USING THE SAME

(71) Applicants: Hyundai Motor Company, Seoul (KR); Kia Motors Corporation, Seoul (KR)

(72) Inventor: Nam-Seok YUN, Hwaseong-Si (KR)

(73) Assignees: Hyundai Motor Company, Seoul (KR); Kia Motors Corporation, Seoul (KR)

(21) Appl. No.: 16/593,395

(22) Filed: Oct. 4, 2019

(30) Foreign Application Priority Data
Jan. 8, 2019 (KR) 10-2019-0002170

(51) Int. Cl. B60H 3/00

(52) U.S. Cl. CPC B60H 3/0078; B60H 2003/065; B60H 3/0085

(57) ABSTRACT

An air cleaner may include an electrostatic air cleaner including: an air cleaner casing; an air cleaner main body; and an air cleaner return grille cover which is coupled to the air cleaner casing, wherein the air cleaner main body may include: a filter unit which has a size greater than a predetermined particle size; a dust collector unit which secondarily filters out dust, which passes through the filter unit and has a size equal to or smaller than the predetermined particle size, by collecting the dust on an electrode plate by generating a high-tension arc; a converter unit which generates the high-tension arc on the dust collector unit; and a sensor unit which measures concentration of the dust having a size equal to or smaller than the predetermined particle size to operate the dust collector unit and the converter unit.

### CROSS-REFERENCE TO RELATED APPLICATIONS

The present application claims priority to Korean Patent Application No. 10-2019-0002170, filed on Jan. 8, 2019, the entire contents of which is incorporated herein for all purposes by this reference.

### BACKGROUND OF THE INVENTION

### Field of the Invention

The present invention relates to an air cleaner and an air cleaning method. More specifically, the present invention relates to an air cleaner for an express bus and an air cleaning method.

### Description of Related Art

Recently, a problem of (ultra-)fine dust becomes a serious issue, and the Korean government are preparing various types of solution for solving the problem of (ultra-)fine dust.

Korea is increasingly influenced by (ultra-)fine dust from China mainly in the winter and spring, and air quality in Korea has become worse due to a lack of precipitation caused by unexpected weather conditions. Therefore, the Korean government strengthens regulations related to the management of air pollution and internal air quality. For example, recently, the Korean government increases reference values for managing ultra-fine dust (PM 2.5), strengthens regulations for preventing atmosphere environmental pollution, and examines solutions for preparing national health care related to internal air quality in public transportation. The Korean government also tightens up environmental laws to a level in advanced countries.

Ordinary persons are also very interested in health care against (ultra-)fine dust, and demands for various types of associated hygiene products and services are also increased. In particular, ordinary persons always use public transportation such as subways or buses, and thus there is a persistent demand for a system for managing a fine dust level in a vehicle.

Generally, in the case of an air cleaning system disposed in a bus, a system including multiple layers including particle filters, active carbon, and PET is mounted at an air return grill side of the air conditioning unit, such that dust having various sizes are attached to the filters and thus filtered out while air in the vehicle passes through the filters as a blower of the air conditioning unit operates. However, the present method is not suitable to remove (ultra-)fine dust, and it is not easy to replace and manage the system, and as a result, there is a demand for a fundamental improvement to implement a consistent air cleaning system having a higher performance.

The information disclosed in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing an air cleaner for an express bus and an air cleaning method which are configured for filtering out even (ultra-)fine dust.

The present invention, in various aspects, has also been made in an effort to provide an air cleaner for an express bus and an air cleaning method in which maintainability and mountability are improved.

The present invention, in various aspects, has also been made in an effort to provide an air cleaner for an express bus and an air cleaning method which are improved and applicable to a system in the related art without requiring separate and additional construction or costs.

Various aspects of the present invention are directed to providing an electrostatic air cleaner for an express bus, the electrostatic air cleaner including: an air cleaner casing which is configured to be coupled to a roof formed at a lower side of an air conditioning unit of the express bus; an air cleaner main body which is coupled to the air cleaner casing; and an air cleaner return grille cover which is coupled to the air cleaner casing to protect the air cleaner main body, in which the air cleaner main body may include: a filter unit which primarily filters out dust which exists in the express bus and has a size greater than a predetermined particle size; a dust collector unit which secondarily filters out dust, which passes through the filter unit and has a size equal to or smaller than the predetermined particle size, by collecting the dust on an electrode plate by generating a high-tension arc; a converter unit which generates the high-tension arc on the dust collector unit; and a sensor unit which measures concentration of the dust having a size equal to or smaller than the predetermined particle size to operate the dust collector unit and the converter unit.

The air cleaner return grill cover may be coupled to one side of the air cleaner casing by a fastening mechanism and coupled to the other side of the air cleaner casing by a detachable fixing mechanism.

The fastening mechanism may be a hinge, and the detachable fixing mechanism may be a hook system.

The air cleaner main body may be coupled to both sides of the air cleaner casing by a fastening mechanism.

The dust collector unit and the converter unit may operate when the air conditioning unit operates in a recirculation mode.

The predetermined particle size may be a diameter of 10 μm or 2.5 μm.

Various aspects of the present invention are directed to providing an air cleaning method using an electrostatic air cleaner for an express bus, the air cleaning method including: measuring a concentration of fine dust (PM 10) and a concentration of ultra-fine dust (PM 2.5) in an express bus by operating a sensor unit coupled in an electrostatic air cleaner; determining whether a first condition in which the measured concentration of the fine dust (PM 10) is higher than a first predetermined concentration or a second condition in which the measured concentration of the ultra-fine dust (PM 2.5) is higher than a second predetermined concentration is satisfied; determining whether an air conditioning unit operates in a recirculation mode or a fresh air mode when either of the first condition or the second condition is satisfied; operating the air cleaner and a blower coupled in the air conditioning unit when the air conditioning unit operates in the recirculation mode; determining whether a third condition in which the concentration of the fine dust (PM 10) is equal to or lower than the first predetermined concentration and a fourth condition in which the concentration of the ultra-fine dust (PM 2.5) is equal to or lower than the second predetermined concentration are satisfied after elapse of a predetermined time of operating the electrostatic air cleaner and the blower; and stopping the air cleaner and the blower when the third condition and the fourth condition are satisfied.

The first predetermined concentration in the first and third conditions may be 20 to 40 μg/m³, and the second predetermined concentration in the second and fourth conditions may be 10 to 20 μg/m³.

According to an exemplary embodiment of the present invention, it is possible to provide the air cleaner for an express bus and the air cleaning method which are configured for filtering out even (ultra-)fine dust.

Furthermore, according to an exemplary embodiment of the present invention, it is possible to provide the air cleaner for an express bus and the air cleaning method in which maintainability and mountability are improved.

Furthermore, according to an exemplary embodiment of the present invention, it is possible to provide the air cleaner for an express bus and the air cleaning method which are improved and applicable to a system in the related art without requiring separate and additional construction or costs.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view exemplarily illustrating a state in which an electrostatic air cleaner for an express bus according to an exemplary embodiment of the present invention is disassembled.

FIG. 2 is a schematic view exemplarily illustrating a state in which the electrostatic air cleaner for an express bus according to the exemplary embodiment of the present invention is assembled.

FIG. 3 is a cross-sectional view of the air cleaner taken along line C-C in FIG. 2 and illustrates a state in which an air cleaner casing is coupled to a roof formed at a lower side of an air conditioning unit of an express bus.

FIG. 4 is a cross-sectional view of the air cleaner taken along line D-D in FIG. 2 and illustrates a state in which an air cleaner main body is coupled to the air cleaner casing.

FIG. 5 is a cross-sectional view of the air cleaner illustrated in FIG. 2 and illustrates a state in which an air cleaner return grill cover is coupled to the air cleaner casing.

FIG. 6 is a schematic view exemplarily illustrating a state in which the air cleaner illustrated in FIG. 2 is coupled to the roof formed at the lower side of the air conditioning unit of the express bus.

FIG. 7 is a cross-sectional view exemplarily illustrating a state in which the electrostatic air cleaner for an express bus according to the exemplary embodiment of the present invention is coupled to the roof formed at the lower side of the air conditioning unit of the express bus and air in the express bus circulates while passing through the air cleaner and the air conditioning unit.

FIG. 8 is a partially enlarged cross-sectional view of FIG. 7 and illustrates an air flow being introduced from the outside into the inside of the vehicle internal when the air conditioning unit operates in a fresh air mode.

FIG. 9 is a partially enlarged cross-sectional view of FIG. 7 and illustrates an air flow circulating in the vehicle internal when the air conditioning unit operates in a recirculation mode.

FIG. 10 is a flowchart illustrating a method of cleaning air in an express bus by use of the electrostatic air cleaner for an express bus according to the exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

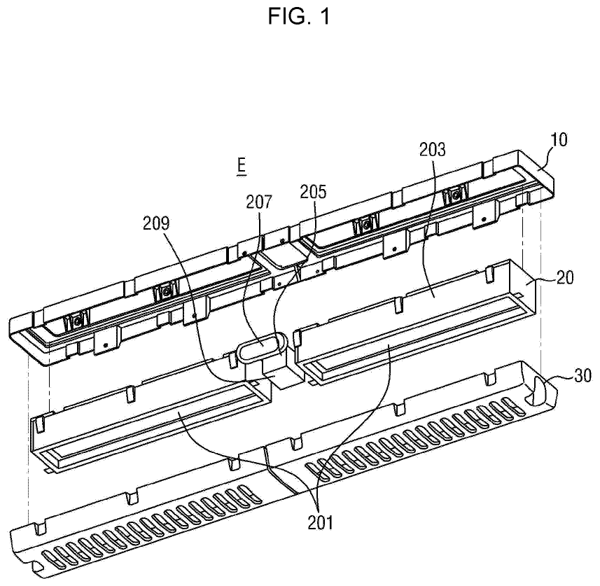

FIG. 1 is a schematic view exemplarily illustrating a state in which an electrostatic air cleaner E for an express bus according to an exemplary embodiment of the present invention is disassembled.

Referring to FIG. 1, the air cleaner E according to an exemplary embodiment of the present invention may include an air cleaner casing 10, an air cleaner main body 20, and an air cleaner return grill cover 30. Here, the air cleaner casing 10 is coupled to a roof formed at a lower side of an air conditioning unit of an express bus, the air cleaner main body 20 is coupled to the air cleaner casing 10, and the air cleaner return grill cover 30 is coupled to the air cleaner casing 10 and may protect the air cleaner main body.

Here, the air cleaner main body 20 may include a filter unit 201, a dust collector unit 203, a converter unit 205, a display 207, and a sensor unit 209. The filter unit 201 may primarily filter out dust which exists in the express bus and has a size greater than a predetermined particle size. The dust collector unit 203 may secondarily filter out dust, which has passed through the filter unit 201 and has a size equal to or smaller than the predetermined particle size, by collecting the dust on an electrode plate by generating a high-tension arc (arc that releases thermal electrons from a cathode and also performs cold cathode emission by an electric field caused by ion space charges). The converter unit 205 may generate the high-tension arc on the dust collector unit 203. The sensor unit 209 may measure concentration of the dust having a size equal to or smaller than the predetermined particle size to operate the dust collector unit 203 and the converter unit 205.

In the instant case, since the filter unit 201 is disposed together with the dust collector unit 203, it is possible to additionally filter out (ultra-)fine dust while maintaining an effect of an air cleaning system in the related art. Since the filter unit 201 primarily filters out the dust having a size greater than the predetermined particle size, it is possible to improve efficiency of performances of the dust collector unit 203 according to an exemplary embodiment of the present invention.

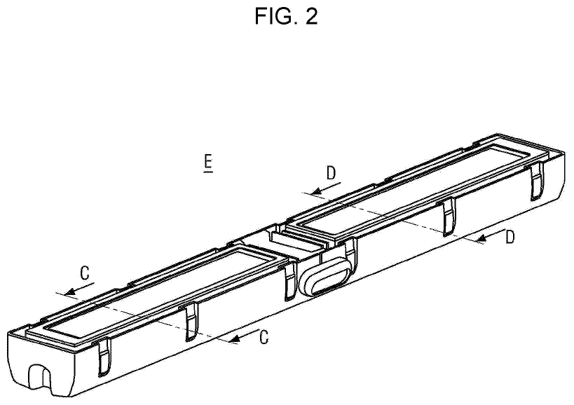

FIG. 2 is a schematic view exemplarily illustrating a state in which the electrostatic air cleaner (EAC) E for an express bus according to the exemplary embodiment of the present invention is integrally mounted.

Referring to FIG. 2, the air cleaner E according to an exemplary embodiment of the present invention is integrally mounted, and the mounted components are organically connected. The organically integrated unit device having a predetermined level (capability) is advantageous in terms of production, costs, feeding, compatibility, and maintenance.

A structure of the air cleaner E according to an exemplary embodiment of the present invention will be described in detail. The EAC main body 20, which substantially filters out fine dust in an express bus, is designed to be easily mounted and/or detached to improve maintainability and mountability thereof.

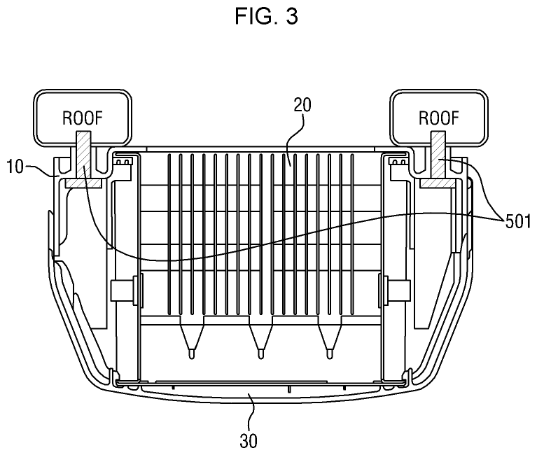

FIG. 3 is a cross-sectional view of the air cleaner taken along line C-C in FIG. 2 and illustrates a state in which the EAC casing is coupled to a roof formed at a lower side of the air conditioning unit A of an express bus.

Referring to FIG. 3, the EAC main body 20, the EAC return grill cover 30, and the EAC casing 10, which are integrally coupled, may be fixedly mounted on the roof as the EAC casing 10 is coupled to the roof by hardware, for example, various types of fastening mechanisms 501. In the instant case, the present coupling does not affect other parts.

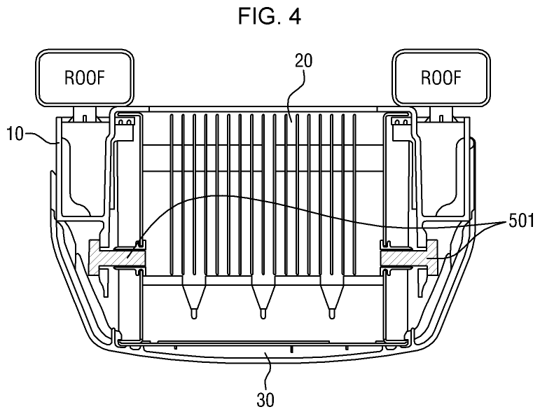

FIG. 4 is a cross-sectional view of the air cleaner taken along line D-D in FIG. 2 and illustrates a state in which the EAC main body is coupled to the EAC casing.

Referring to FIG. 4, the EAC main body 20 may be coupled to both lateral sides of the EAC casing 10 by various types of fastening mechanisms 501. In the instant case, because the EAC main body 20 is not mounted directly on the roof, the present configuration is advantageous when the maintenance needs to be periodically performed. Furthermore, since the EAC main body 20 is coupled to both lateral sides of the EAC casing 10 instead of upper and lower surfaces of the EAC casing 10, the EAC main body 20 may be easily detached downward when the EAC return grill cover 30 is opened in the future.

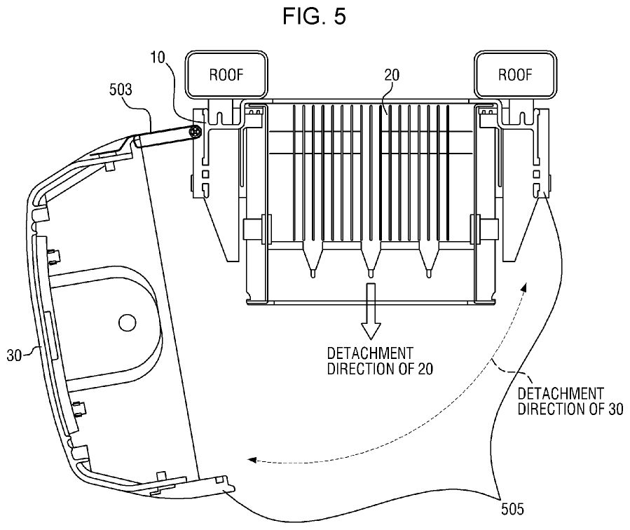

FIG. 5 is a cross-sectional view of the air cleaner illustrated in FIG. 2 and illustrates a state in which the EAC return grill cover 30 is coupled to the EAC casing 10.

Referring to FIG. 5, the EAC return grill cover 30 is coupled to one side of the EAC casing 10 by a fastening mechanism 503 and coupled to the other side of the EAC casing 10 by a detachable fixing mechanism 505. In the instant case, since the EAC return grill cover 30 is not mounted directly on the EAC main body 20, the EAC main body 20 is not affected by vibration or impact while the vehicle travels. Furthermore, the EAC return grill cover 30 is, for example, structured to be coupled to the EAC casing 10 by use of a hinge, which is a stationary fastening mechanism, and a hook system which is a detachable fixing mechanism, and as a result, the EAC main body 20 is easily detached when the cover is opened. In the instant case, it may be seen that the EAC main body 20 may be more easily detached because a detachment direction of the EAC return grill cover 30 and a detachment direction of the EAC main body 20 do not interfere with each other.

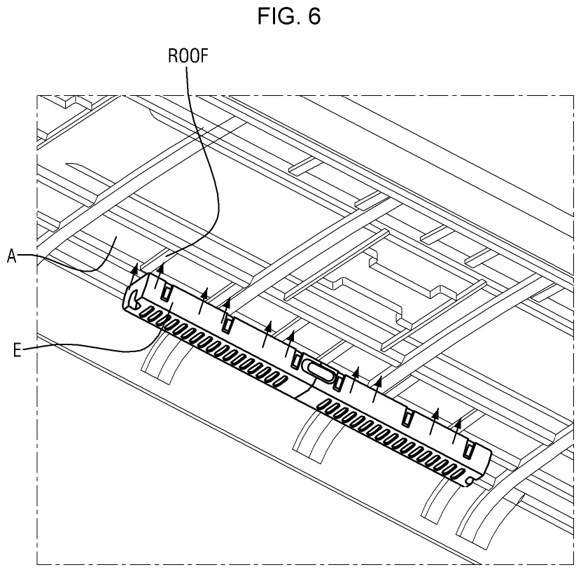

FIG. 6 is a schematic view exemplarily illustrating a state in which the air cleaner illustrated in FIG. 2 is coupled to the roof formed at the lower side of the air conditioning unit of the express bus.

Referring to FIG. 6, the air cleaner E according to an exemplary embodiment of the present invention is directly mounted and coupled to the roof formed at the lower side of the air conditioning unit A of the express bus. In the instant case, the air cleaner E is mounted at the coupling position instead of a position of an air return grill of the air conditioning unit A in which an air cleaning system for a bus in the related art is mounted, and as a result, there is an advantage in that the air cleaner E according to an exemplary embodiment of the present invention may be instantly applied without additionally designing and changing internal and extend instruments or systems in the bus in the related art.

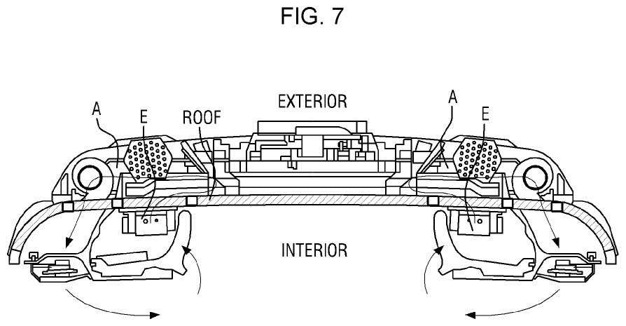

FIG. 7 is a cross-sectional view exemplarily illustrating a state in which the electrostatic air cleaner E for an express bus according to the exemplary embodiment of the present invention is coupled to the roof formed at the lower side of the air conditioning unit A of the express bus and air in the express bus circulates while passing through the air cleaner E and the air conditioning unit A.

Referring to FIG. 7, in the express bus, the air cleaner E according to an exemplary embodiment of the present invention, which is mounted at a return grill side of the air conditioning unit A, which is a passageway through which the air in the vehicle internal is introduced to the air conditioning unit, and substituted for a return grill, is connected to the air conditioning unit A disposed in an outdoor zone above the roof.

In the instant case, air in the vehicle internal is drawn through the return grill side of the air conditioning unit as a blower of the air conditioning unit A operates as necessary. In the instant case, when the mounted air cleaner E according to an exemplary embodiment of the present invention operates, (ultra-)fine dust included in the air in the vehicle internal is attached to and collected on the electrode plate, and only clean air is allowed to pass through the air conditioning unit A and then be discharged to the vehicle internal by the blower.

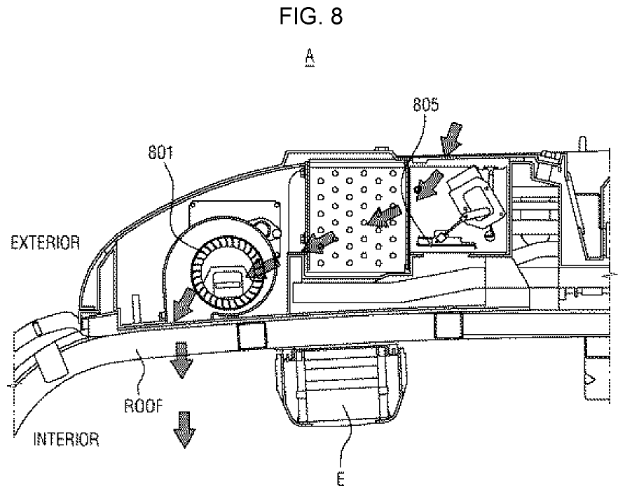

FIG. 8 is a partially enlarged cross-sectional view of FIG. 7 and illustrates an air flow being introduced from the outside into the inside of the vehicle internal when the air conditioning unit operates in a fresh air mode.

Referring to FIG. 8, outside air including dust is continuously supplied into the vehicle internal when the air conditioning unit A operates in the fresh air mode, that is, when a damper door 805 allows the outside air to pass through. In the instant case, when the air cleaner E according to an exemplary embodiment of the present invention operates, there may occur problems in that filtration efficiency rapidly deteriorates, and a vehicle battery is discharged. Therefore, in the instant case, the air cleaner E according to an exemplary embodiment of the present invention does not operate.

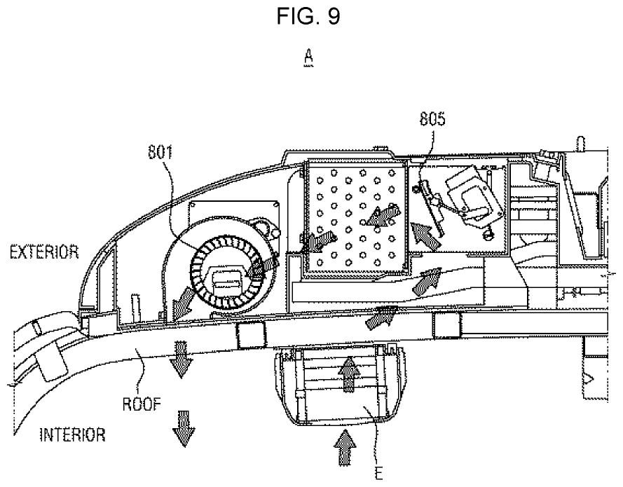

FIG. 9 is a partially enlarged cross-sectional view of FIG. 7 and illustrates an air flow circulating in the vehicle internal when the air conditioning unit operates in a recirculation mode.

Referring to FIG. 9, outside air is not introduced into the vehicle internal when the air conditioning unit A operates in the recirculation mode, that is, when the damper door 805 blocks the outside air. In the instant state, the blower 801 of the air conditioning unit A and the air cleaner E according to an exemplary embodiment of the present invention may operate to filter out (ultra-)fine dust in the vehicle internal. In the instant case, the dust collector unit 203 and the converter unit 205, which form the air cleaner main body 20 according to an exemplary embodiment of the present invention, operate to draw and collect (ultra-)fine dust by use of the high-tension arc.

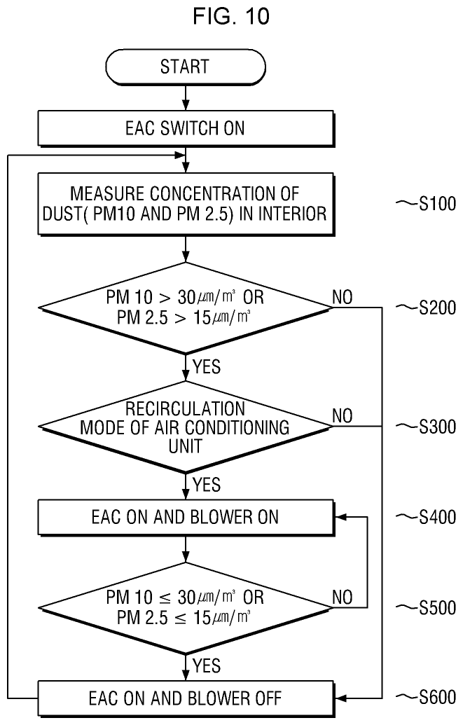

FIG. 10 is a flowchart illustrating a method of cleaning air in an express bus by use of the electrostatic air cleaner for an express bus according to the exemplary embodiment of the present invention.

Referring to FIG. 10, according to the air cleaning method using the air cleaner E according to an exemplary embodiment of the present invention, the sensor unit 209 measures concentration of (ultra-)fine dust in the vehicle internal such that predetermined concentration is determined, and the blower 801 of the air conditioning unit A and the air cleaner E of the present invention operate when the concentration of the (ultra-)fine dust is higher than the predetermined concentration. An HVAC controller for a vehicle may control ON/OFF of the air cleaner E according to an exemplary embodiment of the present invention. In the instant case, the air cleaner E according to an exemplary embodiment of the present invention is actively maintained in an off state when the damper door 805 of the air conditioning unit A is in the fresh air mode. Furthermore, the HVAC controller for a vehicle may control a time interval at which the sensor unit 209 measures (ultra-)fine dust.

The air cleaning method according to an exemplary embodiment of the present invention may include measuring a concentration of fine dust (PM 10) and a concentration of ultra-fine dust (PM 2.5) in an express bus by operating the sensor unit 209 (S100); determining whether the measured concentration of the fine dust (PM 10) or the ultra-fine dust (PM 2.5) is higher than a second predetermined concentration (S200); determining whether the air conditioning unit A operates in the recirculation mode or the fresh air mode when it is determined that either of the measured concentration of the fine dust (PM 10) or the measured concentration of the ultra-fine dust (PM 2.5) is higher than the predetermined concentration (S300); operating the air cleaner E according to an exemplary embodiment of the present invention and the blower 801 of the air conditioning unit A when the air conditioning unit A operates in the recirculation mode (S400); determining whether the concentration of the fine dust (PM 10) and the concentration of the ultra-fine dust (PM 2.5) are equal to or lower than the predetermined concentration after elapse of a predetermined time (S500); and operating the air cleaner E according to an exemplary embodiment of the present invention and the blower 801 of the air conditioning unit A when it is determined that both of the concentration of the fine dust (PM 10) and the concentration of the ultra-fine dust (PM 2.5) are equal to or lower than the predetermined concentration (S600).

The environmental standard, which has been set by the Korean Ministry of Environment at the time of filing the present invention, has been strengthened to a level in advanced countries. According to the environmental standard, the annual average concentration of fine dust (PM 10) is 50 μg/m³ or lower, the daily average concentration of fine dust (PM 10) is 100 μg/m³, the annual average concentration of ultra-fine dust (PM 2.5) is 15 μg/m³ or lower, and the daily average concentration of ultra-fine dust (PM 2.5) is 35 μg/m³.

In the exemplary embodiment of the present invention, based on the reference numerical values, which more strictly indicates “GOOD” in the environmental standard of the Korean Ministry of Environment and are determined such that the daily average concentration of fine dust (PM 10) is 30 μg/m³ and the daily average concentration of ultra-fine dust (PM 2.5) is 15 μg/m³, the range of the ‘predetermined concentration’, when the air cleaner E according to an exemplary embodiment of the present invention operates, is set such that the daily average concentration of fine dust (PM 10) is 20 to 40 μg/m³, and the daily average concentration of ultra-fine dust (PM 2.5) is 10 to 20 μg/m³. With the present strict concentration range, the air cleaner E and the air cleaning method according to an exemplary embodiment of the present invention, which operate only under a predetermined condition and only for a predetermined time period, may achieve a balance between the maintenance of optimally cleaned air and the efficiency of the air cleaning system.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An electrostatic air cleaner comprising:
an air cleaner casing which is configured to be coupled to a roof formed at a lower side of an air conditioning unit of an express bus;
an air cleaner main body which is coupled to the air cleaner casing; and
an air cleaner return grille cover which is coupled to the air cleaner casing to protect the air cleaner main body,
wherein the air cleaner main body includes:
a filter unit which filters out dust which has a size greater than a predetermined particle size;
a dust collector unit which filters out dust, which passes through the filter unit and has the size equal to or smaller than the predetermined particle size, by collecting the dust on an electrode plate by generating a high-tension arc;
a converter unit which generates the high-tension arc on the dust collector unit; and
a sensor unit which measures a concentration of the dust having the size equal to or smaller than the predetermined particle size to operate the dust collector unit and the converter unit.

2. The electrostatic air cleaner of claim 1, wherein the air cleaner return grill cover is coupled to a first side of the air cleaner casing by a fastening mechanism and coupled to a second side of the air cleaner casing by a detachable fixing mechanism.

3. The electrostatic air cleaner of claim 2, wherein the fastening mechanism is a hinge, and the detachable fixing mechanism is a hook system.

4. The electrostatic air cleaner of claim 1, wherein the air cleaner main body is coupled to a first side and a second side of the air cleaner casing by a fastening mechanism.

5. The electrostatic air cleaner of claim 1, wherein the dust collector unit and the converter unit operate when the air conditioning unit operates in a recirculation mode.

6. The electrostatic air cleaner of claim 1, wherein the predetermined particle size is a diameter of 10 μm or 2.5 μm.

7. An air cleaning method using an electrostatic air cleaner, the air cleaning method comprising:
measuring a concentration of fine dust (PM 10) and a concentration of ultra-fine dust (PM 2.5) by operating a sensor unit coupled in the electrostatic air cleaner;
determining when a first condition in which the measured concentration of the fine dust (PM 10) is higher than a first predetermined concentration or a second condition in which the measured concentration of the ultra-fine dust (PM 2.5) is higher than a second predetermined concentration is satisfied;
determining when an air conditioning unit operates in a recirculation mode or a fresh air mode when either of the first condition or the second condition is satisfied;
operating the electrostatic air cleaner and a blower coupled in the air conditioning unit when the air conditioning unit operates in the recirculation mode;
determining when a third condition in which the concentration of the fine dust (PM 10) is equal to or lower than the first predetermined concentration and a fourth condition in which the concentration of the ultra-fine dust (PM 2.5) is equal to or lower than the second predetermined concentration are satisfied after elapse of a predetermined time of operating the electrostatic air cleaner and the blower; and
stopping the electrostatic air cleaner and the blower when the third condition and the fourth condition are satisfied.

8. The air cleaning method of claim 7, wherein the first predetermined concentration in the first and third conditions is 20 to 40 μg/m³, and the second predetermined concentration in the second and fourth conditions is 10 to 20 μg/m³.

9. An air cleaning method using the electrostatic air cleaner of claim 1, the air cleaning method comprising:
measuring a concentration of fine dust (PM 10) and a concentration of ultra-fine dust (PM 2.5) by operating the sensor unit coupled in the electrostatic air cleaner;
determining when a first condition in which the measured concentration of the fine dust (PM 10) is higher than a first predetermined concentration or a second condition in which the measured concentration of the ultra-fine dust (PM 2.5) is higher than a second predetermined concentration is satisfied;
determining when the air conditioning unit operates in a recirculation mode or a fresh air mode when either of the first condition or the second condition is satisfied;
operating the electrostatic air cleaner and a blower coupled in the air conditioning unit when the air conditioning unit operates in the recirculation mode;
determining when a third condition in which the concentration of the fine dust (PM 10) is equal to or lower than the first predetermined concentration and a fourth condition in which the concentration of the ultra-fine dust (PM 2.5) is equal to or lower than the second predetermined concentration are satisfied after elapse of a predetermined time of operating the electrostatic air cleaner and the blower; and
stopping the electrostatic air cleaner and the blower when the third condition and the fourth condition are satisfied.

10. The air cleaning method of claim 9, wherein the first predetermined concentration in the first and third conditions is 20 to 40 μg/m³, and the second predetermined concentration in the second and fourth conditions is 10 to 20 μg/m³.
